(19) United States
(12) Patent Application Publication
(10) Pub. No.: US 2013/0325669 A1
(43) Pub. Date: Dec. 5, 2013

(54) AUTOMATED SHIPPING ADDRESS PROVISION FOR GIFT GIVING PROCESSES

(71) Applicant: Gift Accept, LLC, Wellington, FL (US)

(72) Inventors: Gary Plichta, Boca Raton, FL (US); Dan Gudema, Boca Raton, FL (US); Jean Touboul, Oakland, CA (US); Cass Riese, Boca Raton, FL (US)

(21) Appl. No.: 13/909,041

(22) Filed: Jun. 3, 2013

Related U.S. Application Data
(60) Provisional application No. 61/654,795, filed on Jun. 1, 2012.

(51) Int. Cl. G06Q 30/06; G06Q 50/00

(52) U.S. Cl. CPC G06Q 30/0635; G06Q 50/01
USPC 705/26.82; 705/26.81

(57) ABSTRACT

A method for automated provision of shipping address information for online sales transactions is provided. The method includes receiving a request from an online checkout process for shipping address information for a first friend, providing a portal displaying a social network login interface, receiving confirmation that the consumer has successfully logged into the social network, providing a first interface that displays data identifying a plurality of friends of the consumer, receiving a selection from the consumer identifying the first friend from the first interface, reading contact information for the first friend from the social network, generating a message to the first friend requesting shipping address information, and transmitting the message to the first friend using the contact information that was read, receiving shipping address information from the first friend; and transmitting the shipping address information for the first friend to the online checkout process for completion of the checkout process.

### CROSS-REFERENCE TO RELATED APPLICATIONS

This patent application claims priority to provisional patent application Ser. No. 61/654,795 filed Jun. 1, 2012 and entitled “Automated Shipping Address Provision for Gift Giving Processes.” The subject matter of provisional patent application No. 61/654,795 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to electronic commerce and, more specifically, to processes for facilitating provision of shipping addresses in electronic commerce.

### BACKGROUND

Ecommerce is one of the largest areas of consumer expenditure in the world. Ecommerce spending in the United States will top $250 billion in year 2013 and will top $370 billion by year 2017. In fact, by 2017, U.S. ecommerce spending will account for 10% of all U.S. retail sales. Research shows that as consumers become more experienced buying online, they typically move from buying relatively small and inexpensive items, such as music CDs and books, to pricey, more involved purchases, such as furniture and appliances. As such, ecommerce spending is slated to continue to grow and become an even greater part of all retail sales in the U.S. and globally.

In ecommerce parlance, a shopping cart is a piece of software on a web server that allows visitors to an Internet site to select items for eventual purchase. The software allows online shopping customers to accumulate a list of items for purchase, described metaphorically as “placing items in the shopping cart” or “add to cart.” Upon checkout, the software typically calculates a total for the order, and elicits electronic payment information, as well as shipping address information. When shopping for gifts for others online, however, the most complicated part of the online checkout process may often be finding the shipping address of the gift recipient. Shoppers frequently do not have the shipping address of the gift recipient handy or may not have an updated shipping address. As such, many online shoppers abandon the online checkout process at the shipping address entry phase. In fact, statistics show that each year millions of online shoppers abandon the online check-out process at the shipping address entry phase, representing over $18 billion in lost sales each year.

Therefore, a need exists for improvements over the prior art, and more particularly for more efficient methods and systems for facilitating the provision of shipping addresses in the course of electronic commerce.

### SUMMARY

A method, system and computer program product that automatically provides shipping address information for an online sales transaction is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a method for automated provision of shipping address information for online sales transactions is provided that solves the above-described problem by using an automated process of obtaining and providing the required shipping address data to the sales transaction. The method includes receiving a request from an online checkout process for shipping address information for a first friend of a consumer; providing to the consumer a portal displaying a social network login interface; receiving confirmation that the consumer has successfully logged into the social network; providing a first interface that displays data identifying a plurality of friends of the consumer garnered from the social network; receiving a selection from the consumer identifying the first friend from the first interface; reading contact information for the first friend from the social network; generating a message to the first friend requesting shipping address information, and transmitting the message to the first friend using the contact information that was read; receiving shipping address information from the first friend; and transmitting the shipping address information for the first friend to the online checkout process for completion of the checkout process.

### BRIEF DESCRIPTION OF THE DRAWINGS

The accompanying drawings, which are incorporated in and constitute a part of this disclosure, illustrate various example embodiments. In the drawings:

FIG. 1 is a block diagram of an operating environment that supports the automatic provision of shipping address information for online sales transactions, according to an example embodiment;

FIG. 2 is a diagram showing the data flow of the automatic provision of shipping address information process, according to an example embodiment;

FIG. 3 is a flow chart depicting a general or high-level method for automatic provision of shipping address information for online sales transactions, according to an example embodiment;

FIG. 4 is a flow chart providing detail of steps 302 and 306 of FIG. 3, according to an example embodiment;

FIG. 5 is a flow chart providing detail of step 304 of FIG. 3, according to an example embodiment; and

FIG. 6 is a block diagram of a system including a computing device, according to an example embodiment.

### DETAILED DESCRIPTION

Disclosed methods provide for automatic provision of shipping address information for online sales transactions. The systems and methods of the disclosed embodiments leverage the availability of social network entities to provide a quick and easy way for a consumer or purchaser to obtain a shipping address for a recipient of a gift during the online checkout process, thereby saving time for the consumer and reducing abandoned carts for online retailers. Further, the systems and methods of the present invention improve over the prior art by allowing the recipient of the gift to allow the use of his or her address in shipping the gift without disclosing the address to the buyer of the gift, thereby allowing for privacy. Finally, the disclosed embodiments reduce the time and energy necessary for a gift giver to obtain the gift recipient's address during the online checkout process, while maintaining the continuity of the checkout process.

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

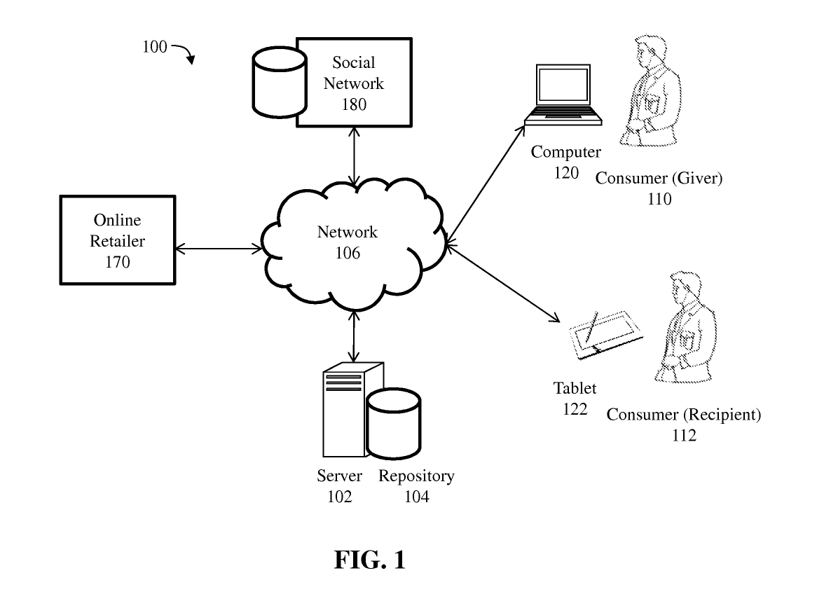

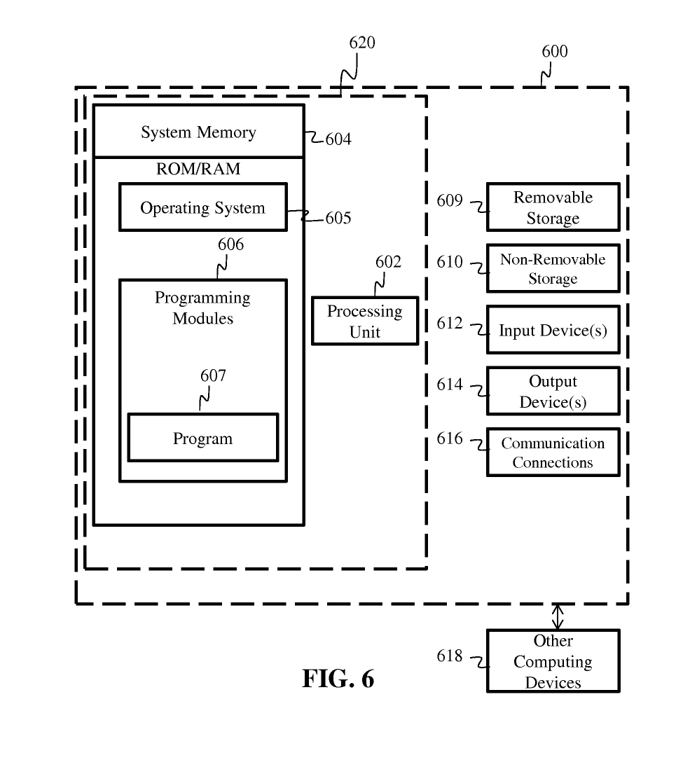

FIG. 1 is a block diagram of an operating environment of a system 100 that supports the automatic provision of shipping address information for online sales transactions, according to an example embodiment. The environment 100 may comprise multiple client or consumer computers 120, 122 and servers 102, 170, 180 communicating via a communications network 106. Each of the client computers 120, 122 and servers 102, 170, 180 may be connected either wirelessly or in a wired or fiber optic form to the communications network 106. Client computers 120, 122 and server 102 may each comprise a computing device 600, described below in greater detail with respect to FIG. 6. FIG. 1 shows that client computers 120, 122 may comprise mobile computing devices such as cellular telephones, smart phones or tablet computers, or other computing devices such as a desktop computer, laptop, game console, for example. Communications network 106 can be a circuit switched network, such as the Public Service Telephone Network (PSTN), or a packet switched network, such as the Internet or the World Wide Web, the global telephone network, a cellular network, a mobile communications network, a WAN, a LAN, or any combination of the above.

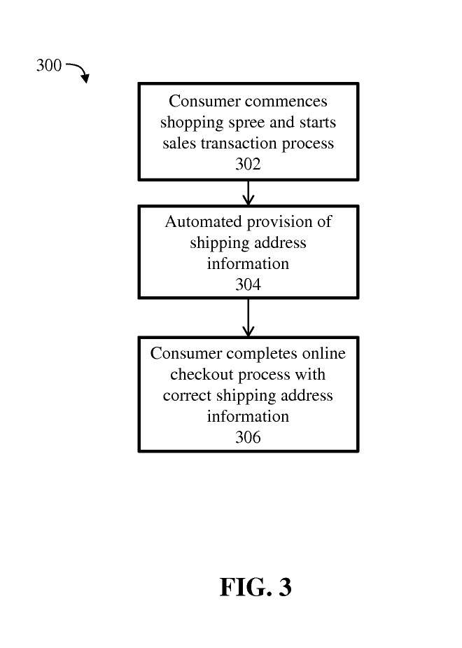

Environment 100 may be used when multiple consumers or customers 110, 112 engage in online sales transactions and related transactions. Online retailer 170 refers to a retailer of goods or services that provides its goods or services for sale online to consumers 110, 112. Each client computer 120, 122 may connect directly or indirectly to retailer 170, as defined in the methods of FIGS. 3-5 below. Social network 180 refers to an online provider of conventional social network services to consumers 110, 112. Each client computer 120, 122 may connect directly or indirectly to social network 180, as defined in the methods of FIGS. 3-5 below.

FIG. 1 further shows that server 102 includes a database or repository 104, which may be a relational database comprising a Structured Query Language (SQL) database stored in a SQL server. Client computers 120, 122 may also each include their own database. The repository 104 serves data from a database, which is a repository for data used by server 102 and the client computers during the course of operation of the invention. The database 104 may include a record for each consumer 110, 112. A consumer record may include: contact/identifying information, shipping address information, sales transaction data, electronic payment information, a unique identifier, login credentials, passwords, login names, demographic data (such as age, sex, income data, race, color, marital status, etc.), or the like.

FIG. 1 shows an embodiment of the present invention wherein networked computing devices 120, 122 interact with servers 102, 170, 180 over the network 106. Server 102 includes a software engine that delivers applications, data, program code and other information to networked computing devices 120, 122 and servers 170, 180. The software engine of server 102 may perform other processes such as transferring data in a stream of packets that are interpreted and rendered by a software application as the packets arrive. It should be noted that although FIG. 1 shows only two networked computing devices 120, 122, and three servers 102, 170 and 180, the system of the present invention supports any number of networked computing devices and servers connected via network 106.

Servers 102, 170 and 180 include program logic 150 comprising computer source code, scripting language code or interpreted language code that is compiled to produce executable file or computer instructions that perform various functions of the present invention. In another embodiment, program logic 150 may be distributed among more than one of servers 102, 170 and 180, computers 120, 122, or any combination of the above. In yet another embodiment, program logic 150 may comprise a programming module, as described in FIG. 6 below.

Note that although each of the servers 102, 170 and 180 are shown as a single and independent entity, in one embodiment of the present invention, the functions of servers 102, 170 and 180 may be integrated with another entity. Further, servers 102, 170 and 180 and their functionality, according to a preferred embodiment of the present invention, can be realized in a centralized fashion in one computer system or in a distributed fashion wherein different elements are spread across several interconnected computer systems.

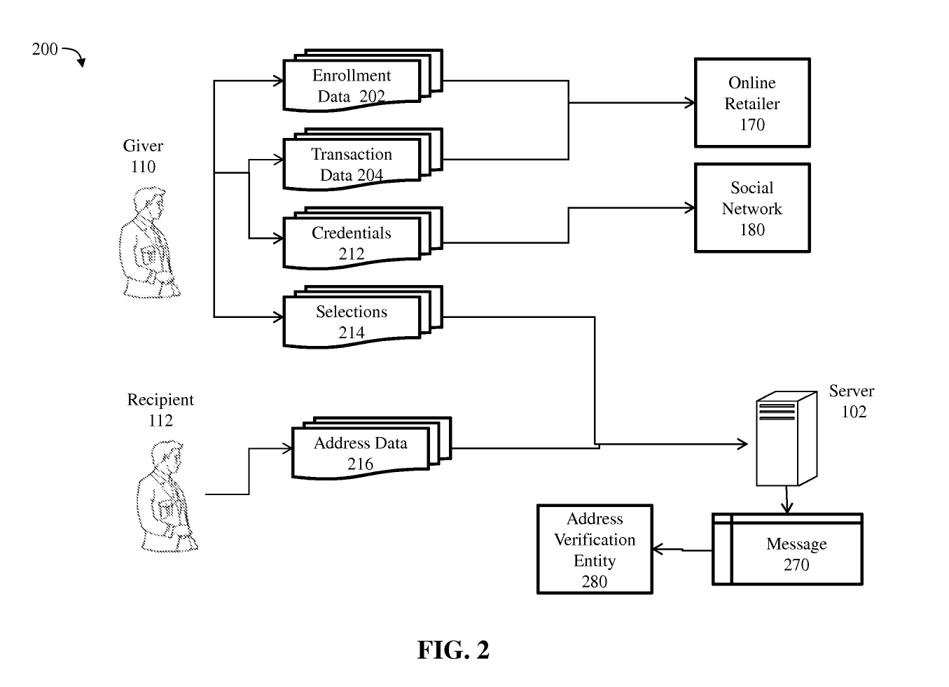

FIG. 2 is a diagram showing the data flow 200 of the automatic provision of shipping address information process, according to an example embodiment. FIG. 2 depicts the transfer of data between, for example, consumers 110, 112 online retailer 170, social network 180 and/or server 102. FIG. 2 shows that consumer 110 may optionally provide enrollment data 202 to online retailer 170 in order to establish an account for consumer 110, and may include contact information, name, email address, telephone number, shipping address information, identifying information, electronic payment information, and data pertaining to social networking contacts of the consumer 110. Enrollment data 202 may also include login credentials, login name, password, and unique identifier for consumer 110. In another embodiment, consumer 110 may optionally provide enrollment data 202 to social network 180 in order to establish an account for consumer 110.

FIG. 2 further shows that the consumer 110 may directly provide sales transaction data 204 to online retailer 170. Sales transaction data comprises any of the data that is used or transferred during a consumer spending transaction, such the identification of the product or service, a unique identifier for the product or service, the price of the product or service, a textual description of the product or service, quantities, electronic payment information, etc. Sales transaction data may also include a unique identifier for the recipient of the product or service, such as a name, email address, telephone number, unique identifier or the like. In one embodiment, the consumer 110 also sends to online retailer 170 the identity of a social network, such as a URL, a unique identifier or other name. FIG. 2 also shows that consumer 110 may provide credentials 214 to social network 180, which may include login credentials, login name, password, secret phrase, authentication, and/or unique identifier for consumer 110.

FIG. 2 further shows that the consumer 112 may provide address data 216, which refers to shipping address information, to the server 102. Finally, FIG. 2 shows that server 102 may provide a message 270 to an address verification entity 280, which has the ability to check the validity of shipping address information and respond with a verification message or a rejection message.

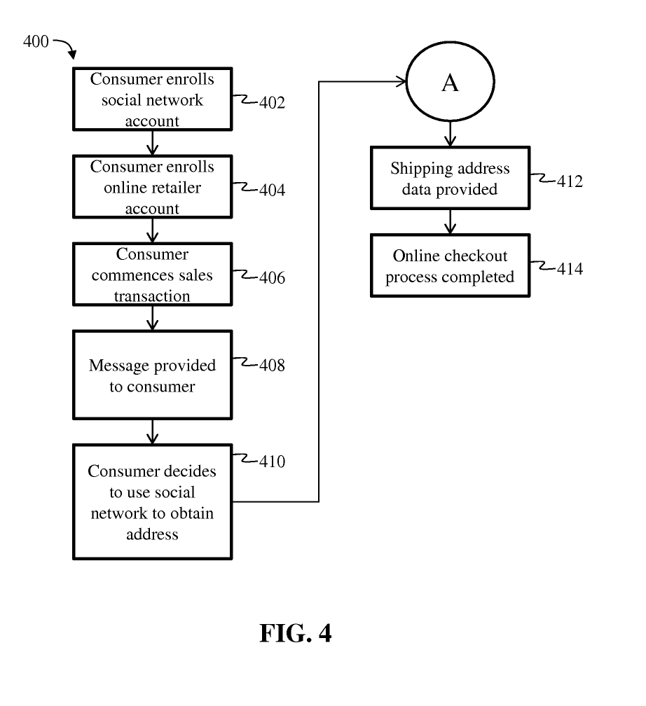

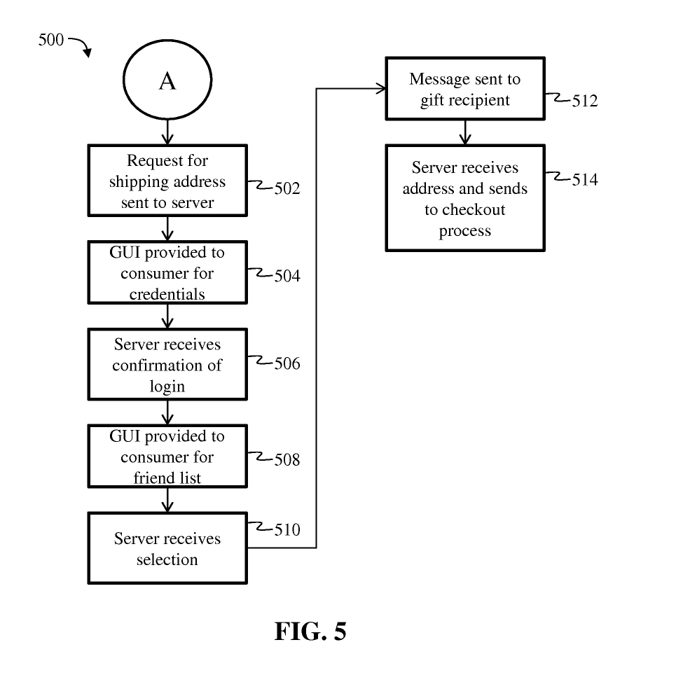

FIG. 3 is a flow chart depicting a general or high-level method 300 for automatic provision of shipping address information for online sales transactions, according to an example embodiment. Flow chart 300 generally describes the interactions and processes that occur when a consumer 110 utilizes the present invention to automatically provide shipping address information during an online sales transaction. The flow chart 300 begins with step 302, when the consumer 110 engages in an online shopping spree and subsequently commences an online sales transaction process without the shipping address of a gift recipient. In step 304, the present invention is engaged, which results in the automated provision of the gift recipient's shipping address information to the online checkout process of the online sales transaction process. Finally, in step 306, the online checkout process continues to completion with the correct shipping address of the gift recipient. Steps 302 and 306 are depicted in greater detail below with reference to FIG. 4 and step 304 is depicted in greater detail below with reference to FIG. 5.

FIG. 4 is a flow chart providing detail of steps 302 and 306 of FIG. 3, according to an example embodiment. Method 400 may begin at optional step 402 wherein the consumer 110 enrolls an account with social network 180 by providing enrollment data 202, as defined in FIG. 2 above. At optional step 404, the consumer 110 enrolls an account with online retailer 170 by providing enrollment data 202, also as defined in FIG. 2 above. Next, in step 406 the consumer 110 commences a sales transaction on the web site of online retailer 170 and subsequently enters sales transaction data 204 into the online retailer 170 via the network 106. In one embodiment of step 406, consumer 110 provides login credentials for, or logs into, online retailer 170 using login credentials that were previously created when consumer 110 enrolled with the retailer 170.

An online sales transaction or process involves a series of steps and functions that are performed by the shopper or consumer 110, the online retailer 170, and possibly third parties, such as payment gateways. The online sales transaction or process also involves a series of data that is entered by the consumer 110, such as contact information and electronic payment information, and data that is accessed by the online retailer 170, such as data about a product selected for purchase or data accessed from a consumer record. The online sales transaction or process may be fully or partially executed, or may be paused or arrested midway, and its current state stored for later execution. This allows consumers to start the online sales transaction or process and finish it at a later time without having to re-enter data. The final stage of an online sales transaction involves the online checkout process. In this stage, the consumer 110 typically enters or selects his electronic payment information, as well as the shipping address information for the product being purchased, and completes the transaction, which may involve a final credit card transaction by a payment gateway. The online checkout process may also be fully or partially executed, or may be paused or arrested midway, and its current state stored for later execution.

Referring back to step 406, in the online checkout process of the online sales transaction, the consumer 110 indicates that he intends to send the product of the sales transaction to a recipient 112. The consumer 110, however, does not possess the shipping address information for recipient 112.

Thus, in step 408 the online retailer 170 displays a message to the consumer 110 asking whether the consumer would like to use his social network account to obtain the shipping address information for the recipient 112. In step 410, the consumer 110 confirms that he would like to use his social network account to obtain the shipping address information for the recipient 112, and the process of FIG. 5 is executed. Also, in this step, the online checkout process of the online sales transaction may be paused or arrested, and its current state stored by retailer 170 for later execution.

In step 412, shipping address information for recipient 112 is received by the online checkout process and the shipping address information is populated into the shipping address text field of the online checkout process. This allows the consumer 110 to continue the online checkout process he has already started, without having to re-enter data, and with the added benefit of having the information he was previously missing—i.e., the shipping address data of the recipient 112. If the consumer 110 has navigated away from the web page of the online checkout process, then the consumer 110 may receive a message (such as an email or a text message) providing a link to a web page that re-initiates the previously stored online checkout process, wherein the shipping address of the recipient 112 is automatically populated into a shipping address text field of the online checkout process. This allows the consumer 110 to continue the online checkout process he has already started, without having to re-enter data, even if he has navigated away from, or closed a web browser displaying, the online checkout process.

In one embodiment, in step 412, the shipping address information of the recipient 112 is occluded such that the consumer 110 may not view the information, thereby protecting the privacy of the recipient 112. Finally, in step 414 retailer 170 completes the sales transaction (such as ordering a final credit card authorization payment using the electronic payment information of the consumer 110) and effectuates the shipment of the product to the shipping address of the recipient 112.

FIG. 5 is a flow chart providing detail of step 304 of FIG. 3, according to an example embodiment. In step 502, the online retailer 170 sends a request to the server 102 indicating that the consumer 110 would like to use his social network account to obtain the shipping address information for the recipient 112. In step 504, a graphical user interface is provided to the consumer 110 to enter his social network account credentials 212. It is well known in the art that a web server configured for serving an online retailer 170 web site may provide a portal to the consumer 110 that allows the consumer 110 to login directly to a defined social network 180. That is, a web page of the web site of online retailer 170 may provide a portal for communicating directly with social network 180, such that the portal is displayed within a web page of the web site of online retailer 170. This process allows the portal to be displayed within the online checkout process being engaged by the consumer 110. Thus, in step 504, the portal is displayed for the consumer 110, who then enters his credentials 212 for social network 180.

Next, in step 506, the server 102 receives confirmation from social network 180 that the consumer 110 has successfully logged into the social network 180. In one embodiment, step 506 comprises the server 102 transmitting a request to the social network 180 requesting information associated with friends of the consumer 110 and receiving, from the social network 180, data identifying a plurality of friends of the consumer garnered from the social network.

In step 508, the server 102 provides a graphical user interface that displays data identifying a plurality of friends of the consumer 110 garnered from the social network 180. The graphical user interface may be displayed within the online checkout process being engaged by the consumer 110. The consumer 110 then interacts with the graphical user interface, such as by entering data into text fields or mouse clicking on buttons, to select a friend from the graphical user interface. The graphical user interface of step 508 is provided within a web page of the web site of online retailer 170.

In step 510, the server 102 receives the selections 214 from the consumer 110 identifying the friend from the graphical user interface and reads the contact information for the friend from the social network 180. Step 510 may comprise reading any one of the following data items for the friend from the social network 180: name, unique identifier, email address, and telephone number.

A “friend” is a characteristic attributed to another person on a social network with which one has a relationship. Note that “friending” someone is the act of sending another user a friend request on a social network. Once the friend request is set, the two people are friends once the receiving party accepts the friend request. In addition to accepting the request, the user has the option of declining the friend request. Other similar terms include “associated” or “linked,” which refer to a link or association between people or users on a social network.

In step 512, the server 102 generates a message to the friend requesting shipping address information, and transmits the message to the friend using the contact information that was read. The message may comprise a message sent via the social network 180, an email sent via the Internet or a text message sent via the telephone system. In step 514, the server 102 receives the shipping address information 216 from the friend (via a message sent via the social network 180, an email sent via the Internet or a text message sent via the telephone system) and subsequently transmits (such as via an HTTP request) the shipping address information 216 for the friend to the online checkout process of retailer 170 for completion of the checkout process at the retailer 170.

In an optional step, after the server 102 has received the shipping address information from the friend, the server 102 transmits the shipping address information to an address verification entity 280, and, before sending the shipping address information to the online checkout process of retailer 170, waits to receive verification of the shipping address information 216 from the address verification entity 280.

In one embodiment of the present invention, steps 504 through 510 above are replaced with the following process. Server 102 provides a graphical user interface to the consumer 110 for entering certain contact information for the recipient 112, such as an email address or telephone number. The consumer 110 provides said contact information via said interface and the server 102 uses said contact information to send the message described in step 512 above.

FIG. 6 is a block diagram of a system including an example computing device 600 and other computing devices. Consistent with the embodiments described herein, the aforementioned actions performed by client computers 120, 122, and servers 102, 170, 180 may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Furthermore, computing device 600 may comprise an operating environment for methods 300, 400, 500 as described above. Methods 300, 400, 500 may operate in other environments and are not limited to computing device 600.

With reference to FIG. 6, a system consistent with an embodiment of the invention may include a plurality of computing devices, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination or memory. System memory 604 may include operating system 605, and one or more programming modules 606. Operating system 605, for example, may be suitable for controlling computing device 600's operation. In one embodiment, programming modules 606 may include, for example, a program module for executing one or more of the actions shown in methods 300, 400 and 500. Furthermore, embodiments of the invention may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. The aforementioned devices are only examples, and other devices may be added or substituted.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 402, programming modules 406 (e.g. a program module) may perform processes including, for example, one or more of method 300's, 400's, 500's steps as described above. The aforementioned processes are examples, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for automated provision of shipping address information for online sales transactions, comprising:
receiving a request from an online checkout process for shipping address information for a first friend of a consumer;
providing to the consumer a portal displaying a social network login interface;
receiving confirmation that the consumer has successfully logged into the social network;
providing a first interface that displays data identifying a plurality of friends of the consumer garnered from the social network;
receiving a selection from the consumer identifying the first friend from the first interface;
reading contact information for the first friend from the social network;
generating a message to the first friend requesting shipping address information, and transmitting the message to the first friend using the contact information that was read;
receiving shipping address information from the first friend;
transmitting the shipping address information for the first friend to the online checkout process for completion of the checkout process.

2. The method of claim 1, wherein the step of providing to the consumer a portal displaying a social network login interface further comprises providing to the consumer the portal displaying the social network login interface, wherein the social network login interface is displayed within the online checkout process.

3. The method of claim 2, wherein the step of receiving confirmation that the consumer has successfully logged into the social network further comprises transmitting a request to the social network requesting information associated with friends of the consumer and receiving, from the social network, data identifying a plurality of friends of the consumer garnered from the social network.

4. The method of claim 3, wherein the step of providing a first interface that displays data identifying a plurality of friends of the consumer garnered from the social network further comprises providing the first interface that displays data identifying the plurality of friends of the consumer garnered from the social network, wherein the first interface is displayed within the online checkout process.

5. The method of claim 4, wherein the step of receiving a selection from the consumer identifying the first friend from the first interface further comprises detecting a mouse click from the consumer on the first interface, said mouse click identifying the first friend from the first interface.

6. The method of claim 5, wherein the step of reading contact information for the first friend from the social network further comprises reading any one of the following data items for the first friend from the social network: name, unique identifier, email address, and telephone number.

7. The method of claim 6, wherein the step of transmitting the message to the first friend further comprises transmitting any one of a message via the social network, an email or a text message.

8. The method of claim 7, wherein the step of receiving shipping address information from the first friend further comprises receiving any one of a message via the social network, an email or a text message.

9. The method of claim 8, wherein the step of transmitting the shipping address information for the first friend further comprises transmitting an HTTP request.

10. The method of claim 9, further comprising a step before the step of transmitting the shipping address information of:
transmitting the shipping address information to an address verification entity; and
receiving verification of the shipping address information from the address verification entity.

11. A method for automated provision of shipping address information for online sales transactions, comprising:
receiving a request from an online checkout process for shipping address information for a first friend of a consumer;
providing a first interface to the consumer eliciting contact information for the first friend;
receiving contact information for first friend, entered by the consumer into the first interface;
generating a message to the first friend requesting shipping address information, and transmitting the message to the first friend using the contact information that was received;
receiving shipping address information from the first friend;
transmitting the shipping address information for the first friend to the online checkout process for completion of the checkout process.

12. The method of claim 11, wherein the step of providing a first interface to the consumer eliciting contact information for the first friend further comprises providing the first interface to the consumer eliciting contact information for the first friend, wherein the first interface is displayed within the online checkout process.

13. The method of claim 12, wherein the step of receiving contact information for first friend further comprises receiving any one of the following data items for the first friend: email address and telephone number.

14. The method of claim 13, wherein the step of transmitting the message to the first friend further comprises transmitting any one of an email or a text message.

15. The method of claim 14, wherein the step of receiving shipping address information from the first friend further comprises receiving any one of an email or a text message.

16. The method of claim 14, wherein the step of transmitting the shipping address information for the first friend further comprises transmitting an HTTP request.

17. A computer-readable storage medium storing executable instructions, which, when executed, cause automated provision of shipping address information for online sales transactions, the computer-readable storage medium comprising:
instructions for receiving a request from an online checkout process for shipping address information for a first friend of a consumer;
instructions for providing to the consumer a portal displaying a social network login interface;
instructions for receiving confirmation that the consumer has successfully logged into the social network;
instructions for providing a first interface that displays data identifying a plurality of friends of the consumer garnered from the social network;
instructions for receiving a selection from the consumer identifying the first friend from the first interface;
instructions for reading contact information for the first friend from the social network;
instructions for generating a message to the first friend requesting shipping address information, and transmitting the message to the first friend using the contact information that was read;
instructions for receiving shipping address information from the first friend;
instructions for transmitting the shipping address information for the first friend to the online checkout process for completion of the checkout process.

18. The computer-readable storage medium of claim 17, wherein the instructions for providing to the consumer a portal displaying a social network login interface further comprise instructions for providing to the consumer the portal displaying the social network login interface, wherein the social network login interface is displayed within the online checkout process.

19. The computer-readable storage medium of claim 18, wherein the instructions for receiving confirmation that the consumer has successfully logged into the social network further comprises instructions for transmitting a request to the social network requesting information associated with friends of the consumer and receiving, from the social network, data identifying a plurality of friends of the consumer garnered from the social network.

20. The computer-readable storage medium of claim 19, wherein the instructions for providing a first interface that displays data identifying a plurality of friends of the consumer garnered from the social network further comprises instructions for providing the first interface that displays data identifying the plurality of friends of the consumer garnered from the social network, wherein the first interface is displayed within the online checkout process.
